(19) United States
(12) Patent Application Publication
(10) Pub. No.: US 2024/0115074 A1
(43) Pub. Date: Apr. 11, 2024

(54) SANDWICH ROLL HOLDER

(71) Applicant: JEFFERY BARON LESPERANCE, HOWELL, MI (US)

(72) Inventor: JEFFERY BARON LESPERANCE, HOWELL, MI (US)

(21) Appl. No.: 18/481,980

(22) Filed: Oct. 5, 2023

Related U.S. Application Data
(60) Provisional application No. 63/413,948, filed on Oct. 6, 2022.

(51) Int. Cl. A47J 37/07

(52) U.S. Cl. CPC A47J 37/0786; A47J 2037/0795

(57) ABSTRACT

The disclosure directed to a sandwich roll holder. The disclosure is further directed to a sandwich roll holder for use in warming, toasting, or heating sandwich rolls in proximity to a heat source, including toasting sandwich rolls over a barbeque. The sandwich roller holder may include collapsible elements that selectively receive one or more sandwich rolls while in an upright or extended position. The sandwich roll holder collapsible elements may also be configured to fold from the upright or extended position to a stowed position such that the sandwich roll holder may be conveniently stored or cleaned.

### CROSS-REFERENCE TO RELATED APPLICATIONS

This application claims priority benefit of U.S. Provisional Application No. 63/413,948, filed on Oct. 6, 2022, the entire contents and disclosures of which are incorporated herein by reference.

### BACKGROUND

### 1. Field of the Disclosure

This disclosure is directed to a sandwich roll holder. The disclosure is further directed to a sandwich roll holder for use in warming, toasting, or heating sandwich rolls in proximity to a heat source, including toasting sandwich rolls over a barbeque.

### 2. Description of the Background

Sandwich rolls can include a plurality of types, shapes, and sizes. Often sandwich rolls are elongated loaves, such as those used for hot dogs, submarine/hoagie sandwiches, or for bratwurst or other sausages.

Many sandwich rolls, or “buns” are premade in large volumes in factory bakeries. These buns are often machine cut as part of the baking process. The cut in the buns runs typically lengthwise along one edge of the buns, but not extending completely through the buns to create to separate or nearly separate halves. As a result, the buns are ready for a user to pry open to insert a hot dog, bratwurst, sausage, or other foodstuff.

Depending upon the type of bread that makes up the bun, the strength of the bun, that is its resistance to tearing completely in half when pried open, varies greatly. Also, due to the vagaries of manufacturing and the low tolerance level of the baking process (particularly the partial slicing open of the buns), each pre-sliced bun is vulnerable to tearing if pried open too far.

When barbequing, that is, cooking over an open flame, either using charcoal, propane, natural gas, or a campfire, it is often desired to warm or toast buns. The reasons for this are many. One such reason is the desire to warm the buns from below room temperature so that the buns do not cool the hot dogs or other food placed within, such as if the buns were stored in a cool location, such as a cooler or a refrigerator. Another reason is the desire to toast the buns to give the buns additional strength. For example, toasted bread is more rigid than untoasted bread and therefore resists deformation and also the absorption of fluids from the food placed within. Often hot dogs, for example, are not served plain, but additional ingredients and/or condiments are added. There are many such additions including mustard, even ketchup for some, pickle relish, onions, ranch dressing, etc. Many “gourmet” hot dogs include many ingredients, such as a “Chicago style” hot dog. Toasting of buns for these hot dogs gives the buns additional strength and allows the consumer to enjoy hot dogs without soggy buns.

However, the desire to toast or warm buns leads to a problem. If the buns are pried open the unsliced portion, or “hinge” may not be uniform or be of sufficient thickness to resist tearing. As one who consumes hot dogs is well aware, nothing is worse than eating a hot dog with bun that is separating or has separated into two halves. The consumer is forced to hold the hot dog and its bun very firmly, as putting it down will result in the total structural failure of the entire hot dog, bun and all.

Often, when hot dogs are prepared, the buns are toasted by prying them open in a “V” shape, and placing them on grill for example. This approach can lead to problems previously discussed above. Prying the buns too widely, in a desire to toast the insides of the buns, where the hot dog and condiments will be placed and where strength and fluid resistance is most desired, often leads to the overstressing of the buns' hinges and possible failure of the buns before they are consumed.

What is needed then is an apparatus or device for warming or toasting buns, such as but not limited to hot dog buns, that provides support for the buns and particularly the “hinge” section of the buns, preventing the hinges from being stressed when opened for toasting, yet provides a device for safely placing the buns over a heat source to expose the interiors of the buns for warming or toasting.

### SUMMARY

The present disclosure overcomes the problems and disadvantages associated with current strategies and designs and provides new tools and methods for a sandwich roll holder for at least warming and/or toasting sandwich rolls.

One embodiment of the disclosure is directed to a sandwich roll holder for holding at least one sandwich roll.

Another embodiment of the disclosure is directed to a sandwich roll holder for holding at least one sandwich roll with a handle for a user.

Another embodiment of the disclosure is directed to a sandwich roll holder for holding at least one sandwich roll over a heat source with a handle for a user.

Another embodiment of the disclosure is directed to a sandwich roll holder for holding at least one sandwich roll that is pre-sliced.

Another embodiment of the disclosure is directed to a sandwich roll holder for holding at least one sandwich roll that is pre-sliced by the hinge of the at least one sandwich roll.

Another embodiment of the disclosure is directed to a sandwich roll holder for holding a plurality of sandwich rolls.

Another embodiment of the disclosure is directed to a sandwich roll holder for holding a plurality of sandwich rolls with a handle for a user.

Another embodiment of the disclosure is directed to a sandwich roll holder for holding a plurality of sandwich rolls over a heat source with a handle for a user.

Another embodiment of the disclosure is directed to a sandwich roll holder for holding a plurality of sandwich rolls that are pre-sliced.

Another embodiment of the disclosure is directed to a sandwich roll holder for holding a plurality of sandwich rolls that are pre-sliced by the hinges of the plurality of sandwich rolls.

Another embodiment of the disclosure is directed to a sandwich roll holder including a frame, where the frame includes a pair of side members disposed planarly between and joined to a pair of end members, a plurality of pairs of opposing support members, the plurality of pairs of opposing support members extending at least from one of the pair of side members and the pair of end members, where one end of each of the opposing support members is joined to at least one of the pair of side members and the pair of end members and the other end of the each of the pairs of opposing support members is joined to at least one of a plurality of crossbar members, where the plurality of crossbar members is disposed between the pairs of opposing support members such that opposing angles are formed between the pairs of opposing support members relative to the pair of side members.

Another embodiment of the disclosure is directed to a sandwich roll holder further includes at least one handle joined to at least one of the pairs of side members.

Another embodiment of the disclosure is directed to a sandwich roll holder further includes at least one handle joined to at least one of the pairs of end members.

Another embodiment of the disclosure is directed to a sandwich roll holder further includes at least one handle joined to at least one of the pairs of side members and at least one of the pairs of end members.

Another embodiment of the disclosure is directed to a sandwich roll holder where the pair of side members and the pair of end members are combined in a continuous element of the frame.

Another embodiment of the disclosure is directed to a sandwich roll holder where the pair of side members and the pair of end members are linear members.

Another embodiment of the disclosure is directed to a sandwich roll holder where the crossbar members are linear members.

Another embodiment of the disclosure is directed to a sandwich roll holder including a frame, where the frame includes a pair of side members disposed between and joined to a pair of end members, a plurality of pairs of opposing support members, the plurality of pairs of opposing support members extending at least from one of the pair of side members and the pair of end members, where one end of each of the opposing support members is rotatably joined to at least one of the pair of side members and rotatably joined to the pair of end members and the other end of the each of the pairs of opposing support members is rotatably joined to at least one of a plurality of crossbar members, where the plurality of crossbar members is disposed between the pairs of opposing support members such that opposing angles are formed between the pairs of opposing support members relative to the pair of side members, where at least one of the plurality of pairs of opposing support members and the plurality of crossbar members include a selectively positionable and engageable joint.

Another embodiment of the disclosure is directed to a sandwich roll holder including a handle joined to at least one of the pairs of side members.

Another embodiment of the disclosure is directed to a sandwich roll holder including a handle joined to at least one of the pairs of end members.

Another embodiment of the disclosure is directed to a sandwich roll holder including a handle joined to at least one of the pairs of side members and at least one of the pairs of end members.

Another embodiment of the disclosure is directed to a sandwich roll holder where the pair of side members and the pair of end members are combined in a single element of the frame.

Another embodiment of the disclosure is directed to a sandwich roll holder where the pair of side members and the pair of end members are linear members.

Another embodiment of the disclosure is directed to a sandwich roll holder where the crossbar members are linear members.

Another embodiment of the disclosure is directed to a sandwich roll holder including a frame, where the frame further comprises a pair of side sections disposed planarly between and joined to a pair of end sections, in the form of a continuous element, a plurality of pairs of opposing support members, the plurality of pairs of opposing support members extending at least from one of the pair of side sectional members and the pair of end sectional members, where one end of each of the opposing support members is rotatably joined to at least one of the pair of side members and rotatably joined to the pair of end members and the other end of the each of the pairs of opposing support members is rotatably joined to at least one of a plurality of crossbar members, where the plurality of crossbar members is disposed between the pairs of opposing support members such that opposing angles are formed between the pairs of opposing support members relative to the pair of side sections, where at least one of the plurality of pairs of opposing support members and the plurality of crossbar members include a selectively positionable and engageable joint.

Another embodiment of the disclosure is directed to a sandwich roll holder including a handle joined to at least one of the pairs of side members.

Another embodiment of the disclosure is directed to a sandwich roll holder including a handle joined to at least one of the pairs of end sections.

Another embodiment of the disclosure is directed to a sandwich roll holder including a handle joined to at least one of the pairs of side sections and at least one of the pairs of end sections.

Another embodiment of the disclosure is directed to a sandwich roll holder where the pair of side sections and the pair of end sections are combined in a single element of the frame.

Another embodiment of the disclosure is directed to a sandwich roll holder where the crossbar members are linear members.

Other embodiments and advantages of the disclosure are set forth in part in the description, which follows, and in part, may be obvious from this description, or may be learned from the practice of the disclosure.

### DESCRIPTION OF THE FIGURES

The disclosure is described in greater detail by way of example only and with reference to the attached drawings, in which:

FIG. 1 is a perspective view of a sandwich roll holder according to an embodiment of the present disclosure;

FIG. 2 is a side view of a sandwich roll holder according to an embodiment of the present disclosure;

FIG. 3 is a side view a folded sandwich roll holder according to an embodiment of the present disclosure;

FIG. 4 is a front view of a portion of a sandwich roll holder according to an embodiment of the present disclosure;

FIG. 5 is a rear view of a portion of a sandwich roll holder according to an embodiment of the present disclosure

FIG. 6 is a top view of a sandwich roll holder according to an embodiment of the present disclosure;

FIG. 7 is a bottom view of a sandwich roll holder according to an embodiment of the present disclosure;

FIG. 8 is a side view of a sandwich roll holder according to an embodiment of the present disclosure; and

FIG. 9 is a perspective view of a sandwich roll holder according to an embodiment of the present disclosure.

### DESCRIPTION OF THE DISCLOSURE

As embodied and broadly described herein in the Figures, the present disclosure is directed to a sandwich roll holder (“holder”) 10.

According to one embodiment of the disclosure, holder 10 may be configured in a plurality of forms, shapes, and designs to hold sandwich rolls, such as hot dog buns (“buns”) B.

Holder 10 may include a frame 12. Frame 12 may be configured in a plurality of styles, shapes, and sizes. For illustrative purposes only, frame 12 may be configured using one or more rods, such as stainless-steel rods. It should be understood that some or all of the components of holder 10 may be configured with a variety of shapes, profiles, and attributes. Frame 12 may be configured using rods that include a pair of side members 14 and a pair of end members 16, selectively joined to form a perimeter. For example, frame 12 may be configured with side members 14 and end members 16 to form a rectangle, a square, oval, circle, or other shapes. Side members 14 and end members 16 may be joined by various means, such as welding. In other embodiments, frame 12 may be formed in a single piece, such as by additive manufacturing or stamping. In other embodiments, holder 10 and its components may be made using a variety of methods and techniques, known to those in skilled in the art, as well as techniques not yet developed that may be applicable to forming holder 10.

Holder 10 may include one or more supports 18 that may extend from the frame 12 (including but not limited to side members 14 and/or end members 16) at an angle A that is different from frame 12. For example, supports 18 may extend from frame 12 and an angle A that is 45 degrees. Supports 18 may be configured on frame 12 such that a first support 18 is placed on frame 12 at a first angle A, and a second support 18 is placed on frame 12 at an opposite angle A so that first support 18 and second support 18 intersect and may be joined together to form an “A” style configuration. Additional supports 18 may be configured similarly to create a plurality of “A” style configurations on frame 12. It is understood that angle A may not be uniform throughout holder 10, but may vary according to the shape of holder 10 and/or some or all of its components.

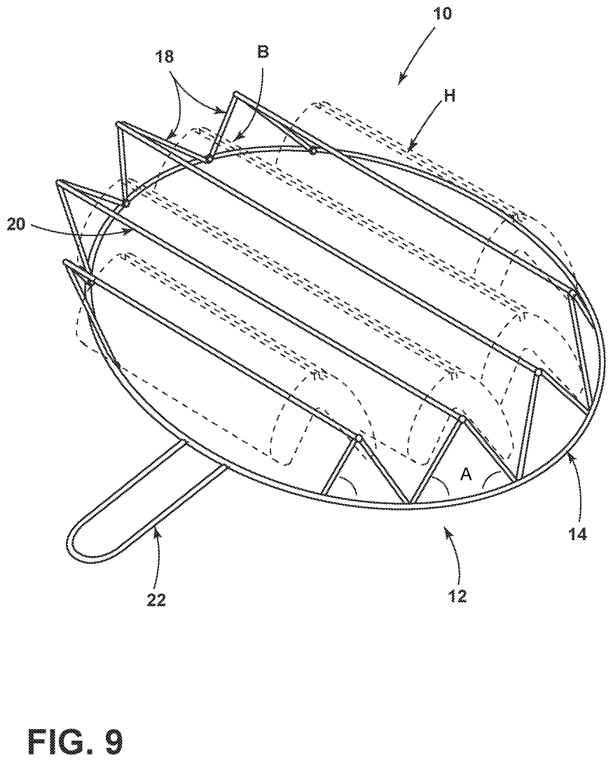

Holder 10 may include one or more crossbars (or selectively hinged rails) 20. Crossbars 20 may be configured to engage the ends of supports 18 opposite the ends of supports 18 that engage frame 12. Crossbars 20 may be configured to be the same or similar length to side members 14 and/or end members 16, for example. Crossbars 20 may be configured to engage and support at least one bun B by contacting the interior hinge H of the bun B (see FIG. 9). By placing the buns B with the sliced edge opened to reveal interior hinge H, the buns B may engage crossbars 20 and allow for the interior edges of buns B to be warmed and/or toasted when holder 10 is placed in proximity to, such as over, a heat source.

Crossbars 20 may be configured to allow for the supports 18 to be elevated (or unstowed) by at least angle A to receive one or more rolls. Crossbars 20 may include a selective locking mechanism that may allow supports 18 to be selectively folded in a stowed position, as indicated in FIG. 3. In the stowed position, holder 10 may take up less space and be easier to store, transport, or clean.

Holder 10 may include one or more handles 22. Handle 22 may be configured of the same material and style as other components of holder 10, such a steel rod. Handle 22 may be configured to allow a user to securely grasp and support holder 10, such as when fully loaded with buns B. Handle 22 may be configured to allow a user to place a loaded holder 10 over a heat source, such as a barbeque, whereby one or more buns B may be warmed and/or toasted and without causing user to be exposed to uncomfortable levels of heat from the heat source (BBQ, etc.) The holder 10 may be configured to expose nearly all of the interior surface of the buns B for warming and/or toasting.

Once the one or more buns B have been sufficiently warmed and/or toasted, user may remove the holder 10 from the heat source, and easily and safely remove the buns B. The now warmed/toasted buns B may then be used to receive a hot dog or other food (grilled vegetables, fish, etc.) and the holder 10 may then be restocked with new, cold buns B for warming/toasting.

Holder 10 or portions thereof may be constructed of a variety of materials. It is contemplated that holder 10 may be configured using steel rods, such as chromed steel rods (or stainless steel rods). The chromed steel rod configuration is highly durable, easily to clean, and attractive. The handle 22 may include additional elements to provide additional grip and/or insulative protection to the user. For example, handle 22 may include a polymer portion that may or may not be selectively removable, such as for washing. It is also contemplated that holder 10 or a portion thereof, may include additional surface treatments, such as knurling, to provide an increased level of friction (and grip) on one or more surfaces of holder 10, such as crossbars 20 and/or handle 22.

Holder 10 may be constructed of other materials, such as those also suited to exposure to heat sources. Other metals, alloys, or combinations thereof may be used. For example, aluminum or alloys thereof may be used to form at least a portion of holder 10. Copper, given its heat transfer properties, may also be used. Other polymers or engineered materials may also be used to construct at least a portion of holder 10.

It should be understood that holder 10 may include additional or multiples of components that make up holder 10. For example, additional side members 14, end members 16, supports 18, and/or hinge rails 20 may be incorporated into embodiments of holder 10. For example, a plurality of hinge rails 20 may extend along supports 18 to provide additional support for buns B. A mesh or screen may also be included to selectively engage portions of the holder 10 and/or the buns B.

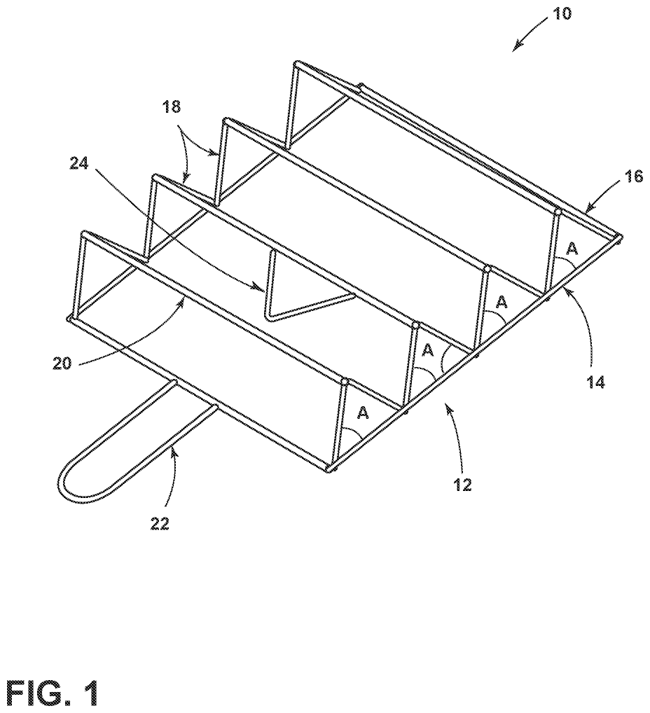

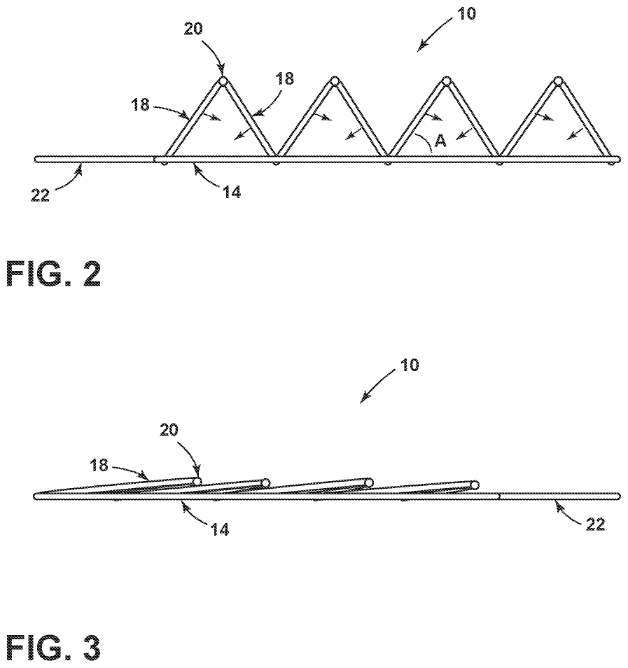

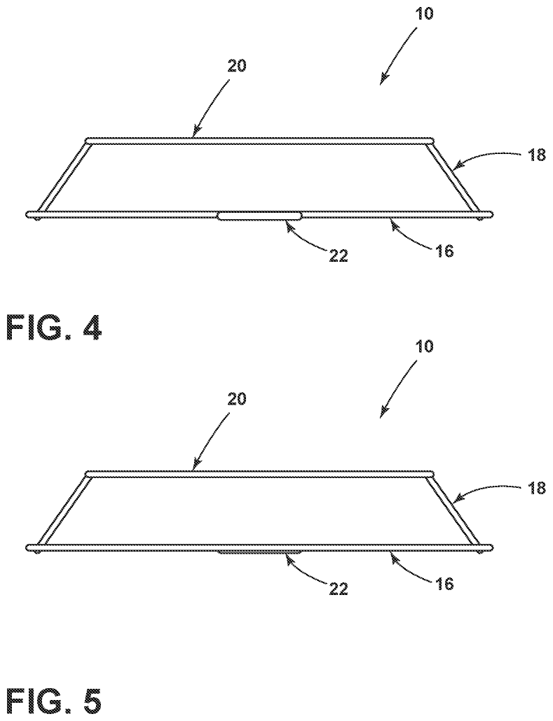

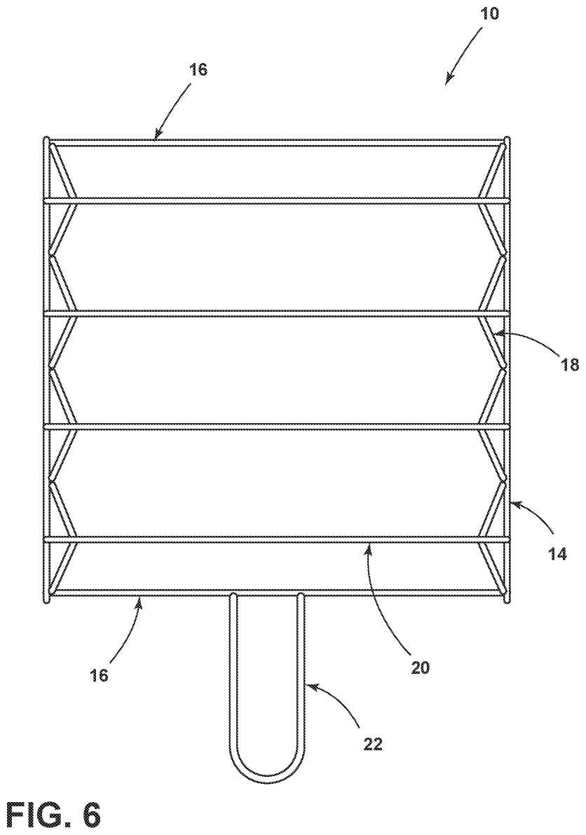

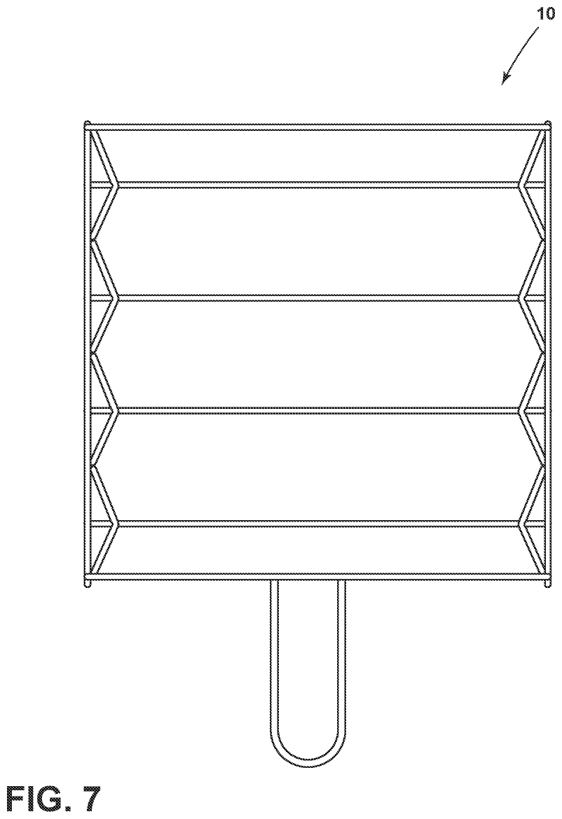

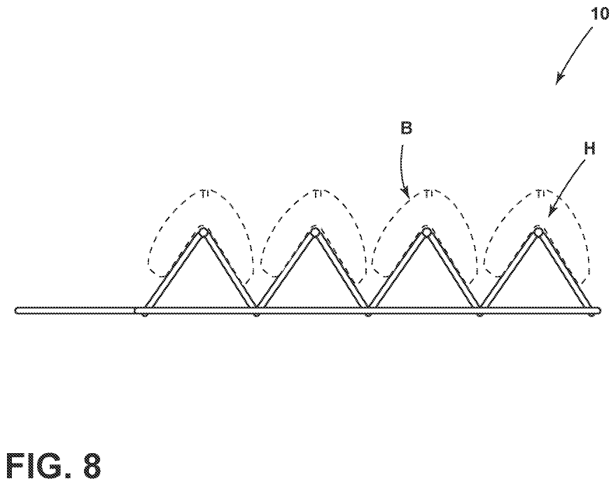

Holder 10 (including some or all of its components) may be configured in various shapes, including but not limited to a square, a rectangle, an oval, or a circle (see FIGS. 1, 9). It is also contemplated that holder 10 may be configured in a variety of other shapes, such as logos of sports teams, other products and companies, letters, animals, and other artistic interpretation of objects both real and imagined. For example, a handle 22 of a holder 10 may be formed to include a team logo, or be configured to receive a team logo formed of a suitable material that is added to handle 22.

It is also contemplated that some components of holder 10 (such as, but not limited to crossbar 20) may be configured to selectively toast or brown portions of the buns B. For example, crossbar 20 may include additional elements 24 (see FIG. 1) to add letters, symbols, images, etc., that transfer their image to the buns B when placed over a heat source (BBQ, etc.). In this way, the buns may be “customized” through the selective heating/browning of buns B. For example, crossbar 20 may include letters pertaining to a particular sports team, or the team's logo. In another example, words, letters, or other designs incorporated into crossbar 20 may allow for these designs to then be transferred to the buns B when heated.

The preceding examples illustrate embodiments of the disclosure, but should not be viewed as limiting the scope of the disclosure. Some or all of the elements in the drawings may or not be to scale relative to each other and/or when taken as a whole.

Other embodiments and uses of the disclosure will be apparent to those skilled in the art from consideration of the specification and practice of the disclosure disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the following claims.

1. A sandwich roll holder comprising:
a frame, wherein the frame includes a pair of side members disposed planarly between and joined to a pair of end members;
a plurality of pairs of opposing support members, the plurality of pairs of opposing support members extending at least from one of the pair of side members and the pair of end members, wherein one end of each of the opposing support members is joined to at least one of the pair of side members and the pair of end members and the other end of the each of the pairs of opposing support members is joined to at least one of a plurality of crossbar members,
wherein the plurality of crossbar members is disposed between the pairs of opposing support members such that opposing angles are formed between the pairs of opposing support members relative to the pair of side members.

2. The sandwich roll holder of claim 1, further comprising at least one handle joined to at least one of the pairs of side members.

3. The sandwich roll holder of claim 1, further comprising at least one handle joined to at least one of the pairs of end members.

4. The sandwich roll holder of claim 1, further comprising at least one handle joined to at least one of the pairs of side members and at least one of the pairs of end members.

5. The sandwich roll holder of claim 1, wherein the pair of side members and the pair of end members are combined in a continuous element of the frame.

6. The sandwich roll holder of claim 1, wherein the pair of side members and the pair of end members are linear members.

7. The sandwich roll holder of claim 6, wherein the crossbar members are linear members.

8. A sandwich roll holder comprising:
a frame, wherein the frame includes a pair of side members disposed between and joined to a pair of end members;
a plurality of pairs of opposing support members, the plurality of pairs of opposing support members extending at least from one of the pair of side members and the pair of end members, wherein one end of each of the opposing support members is rotatably joined to at least one of the pair of side members and rotatably joined to the pair of end members and the other end of the each of the pairs of opposing support members is rotatably joined to at least one of a plurality of crossbar members,
wherein the plurality of crossbar members is disposed between the pairs of opposing support members such that opposing angles are formed between the pairs of opposing support members relative to the pair of side members,
wherein at least one of the plurality of pairs of opposing support members and the plurality of crossbar members include a selectively positionable and engageable joint.

9. The sandwich roll holder of claim 8, further comprising a handle joined to at least one of the pairs of side members.

10. The sandwich roll holder of claim 8, further comprising a handle joined to at least one of the pairs of end members.

11. The sandwich roll holder of claim 8, further comprising a handle joined to at least one of the pairs of side members and at least one of the pairs of end members.

12. The sandwich roll holder of claim 8, wherein the pair of side members and the pair of end members are combined in a single element of the frame.

13. The sandwich roll holder of claim 8, wherein the pair of side members and the pair of end members are linear members.

14. The sandwich roll holder of claim 13, wherein the crossbar members are linear members.

15. A sandwich roll holder comprising:
a frame, wherein the frame further comprises a pair of side sections disposed planarly between and joined to a pair of end sections, in the form of a continuous element;
a plurality of pairs of opposing support members, the plurality of pairs of opposing support members extending at least from one of the pair of side sectional members and the pair of end sectional members, wherein one end of each of the opposing support members is rotatably joined to at least one of the pair of side members and rotatably joined to the pair of end members and the other end of the each of the pairs of opposing support members is rotatably joined to at least one of a plurality of crossbar members,
wherein the plurality of crossbar members is disposed between the pairs of opposing support members such that opposing angles are formed between the pairs of opposing support members relative to the pair of side sections,
wherein at least one of the plurality of pairs of opposing support members and the plurality of crossbar members include a selectively positionable and engageable joint.

16. The sandwich roll holder of claim 15, further comprising a handle joined to at least one of the pairs of side members.

17. The sandwich roll holder of claim 15, further comprising a handle joined to at least one of the pairs of end sections.

18. The sandwich roll holder of claim 15, further comprising a handle joined to at least one of the pairs of side sections and at least one of the pairs of end sections.

19. The sandwich roll holder of claim 15, wherein the pair of side sections and the pair of end sections are combined in a single element of the frame.

20. The sandwich roll holder of claim 15, wherein the crossbar members are linear members.
